(19) United States
(12) Patent Application Publication
(10) Pub. No.: US 2011/0312232 A1
(43) Pub. Date: Dec. 22, 2011

(54) SURFBOARD LEASH SYSTEM AND METHOD

(75) Inventors: James Phil Starck, JR., San Diego, CA (US); George Albert Mansfield, III, San Diego, CA (US)

(73) Assignee: YVUVY, LLC, A CALIFORNIA LIMITED LIABILITY COMPANY, San Diego, CA (US)

(21) Appl. No.: 12/821,106

(22) Filed: Jun. 22, 2010

(51) Int. Cl. B63B 35/85; B23P 11/00

(52) U.S. Cl. 441/75; 29/428

(57) ABSTRACT

A surfboard leash system for a surfboard and a method of making it are disclosed. The system may include an insert or receptacle adapted to be disposed within a portion of the surfboard, a reel assembly releasably connected to the insert and having an arm portion terminating in an annular flange, a first elongated line having a first end attached to the reel assembly and a second end capable of being extended from and retracted to the annular flange of the reel assembly, and a second elongated line releasably connectable at a first end to the second end of the first elongated line and adapted to be releasably attached at a second end to a user of the surfboard.

### FIELD OF THE INVENTION

The present invention relates in general to a surfboard leash and a method of making it. It more particularly relates to a retractable surfboard leash system.

### BACKGROUND ART

There is no admission that the background art disclosed in this section legally constitutes prior art.

Leashes for surfboards have been used for many years to prevent the momentary or permanent loss of one's surfboard should the user fall off of his/her surfboard. The leash interconnects the surfboard to the user's ankle. The intermediate portion of the leash forms a loop that often times drags behind the surfboard during use. This can cause an unwanted drag on the surfboard and can collect undesirable debris such as seaweed.

Thus, there have been many different types and kinds of retractable surfboard leashes proposed to help eliminate slack portion of the leash from dragging behind the surfboard. For example, reference may be made to U.S. Pat. Nos. 4,938,725; 5,490,805; 5,902,164; and 5,938,492; Australian patent 704985; and International patent application publications WO 92/00873; WO 99/51489; and WO 2006/045166. Retractable surfboard leashes have been known and have been contemplated for use for many years.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of a retractable surfboard leash system constructed according to an embodiment of the invention, illustrated being attached to a surfboard;

FIG. 2 is an enlarged scale pictorial view of a reel assembly of the retractable surfboard leash system of FIG. 1;

FIG. 3 is a reduced scale exploded pictorial view of the reel assembly of FIG. 2;

FIG. 4 is a top view of the reel assembly of FIG. 2;

FIG. 5A is a sectional view of the reel assembly of FIG. 4 taken substantially along line A-A thereof;

FIG. 5B is a sectional view of the reel assembly of FIG. 4 taken substantially along line B-B thereof;

FIG. 6 is a partially-broken away enlarged top view of the retractable surfboard leash system of FIG. 1;

FIG. 7 is a sectional view of the retractable surfboard leash system of FIG. 6 taken substantially along line C-C thereof;

FIG. 8 is a partially broken away pictorial view of the retractable surfboard leash system of FIG. 1;

FIG. 9 is a partially broken away pictorial view of the retractable surfboard leash system similar to FIG. 8 with the leash being illustrated disconnected from the reel;

FIG. 10 is a partially broken away sectional pictorial view of the retractable surfboard leash system similar to FIG. 8, being illustrated with a portion of the leash cord being played out from the reel;

FIG. 11 is a pictorial view of the retractable surfboard leash system of FIG. 1, illustrating it being attached to the surfboard at an alternative location;

FIG. 12 is a partially broken away pictorial view of another embodiment of the inventive retractable leash system with an alternative reel output location;

FIG. 13 is a top view of a leash plug for a surfboard according to an embodiment of the invention;

FIG. 14 is a sectional view of the leash plug of FIG. 13 taken substantially along line D-D thereof;

FIG. 15 is a partially broken away pictorial view of another embodiment of the retractable surfboard leash system being capable of being attached to the existing leash plug of a surfboard and being illustrated in the process of being attached to a conventional leash plug mounted to a surfboard;

FIG. 16 is a pictorial view of another embodiment of a reel assembly similar to FIG. 3; and

FIG. 17 is a pictorial view of a quick release leash portion of a retractable surfboard leash system of yet another embodiment.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the system, components and method of the present invention, as represented in the drawings, is not intended to limit the scope of the invention, as claimed, but is merely representative of the embodiments of the invention.

There is disclosed a surfboard leash system and a method of making it. At least one embodiment of the present invention may provide a reel assembly mounted on a surfboard and having a first line or cord capable of being extended and retracted, and a second line/cord connected to the first line/cord and adapted to be connected to a user of the surfboard. The system may enable the user to move freely about the surfboard without having an unwanted excess intermediate slack portion of the line dragging behind in the water.

According to one embodiment of the present invention, the retractable surfboard leash system for a surfboard may include an insert or receptacle adapted to be disposed within the surfboard, and a reel assembly releasably connected to the insert and having an arm portion terminating in an annular flange. A set of seals are provided within the reel assembly to help protect its components from corrosion. In one embodiment of the invention, the reel assembly may include a coil spring, which may be composed of a corrosion resistant material such as elgiloy or other such corrosion resistant material. In yet another embodiment, the real assembly includes a strong thin line composed of suitable material such as Spectra.

According to another important embodiment of the present invention, the retractable surfboard leash system for a surfboard includes a detachable reel assembly releasably connected to an insert fixed to the surfboard. When the reel assembly is removed from the surfboard insert, a leash plug can be releasably attached to the insert so that another leash may be attached alternatively to the leash plug. In this manner, the same inventive reel assembly can be quickly detached from the surfboard and used with other inserts for other surfboards.

According to yet another embodiment of the present invention, the surfboard leash system for a surfboard may include an insert or receptacle adapted to be disposed within the surfboard, conduit means for providing access from the insert to the rear edge of the surfboard, a reel assembly releasably connected to the insert, a first elongated line having a first end attached to the reel assembly and a second end extending through the conduit means and capable of being extended from and retracted to the rear edge of the surfboard, and a second elongated line releasably connectable at a first end to the second end of the first elongated line and adapted to being releasably attached at a second end to a user of the surfboard.

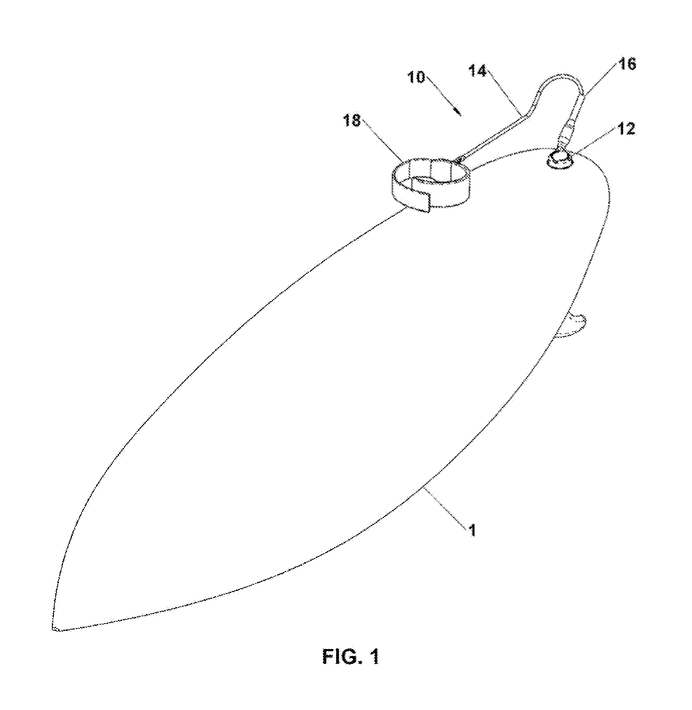

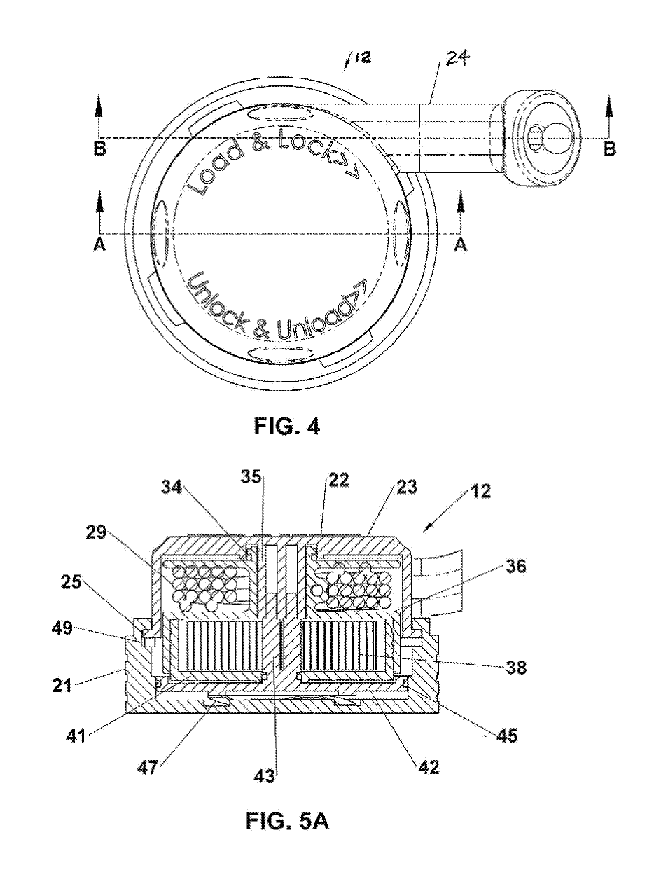

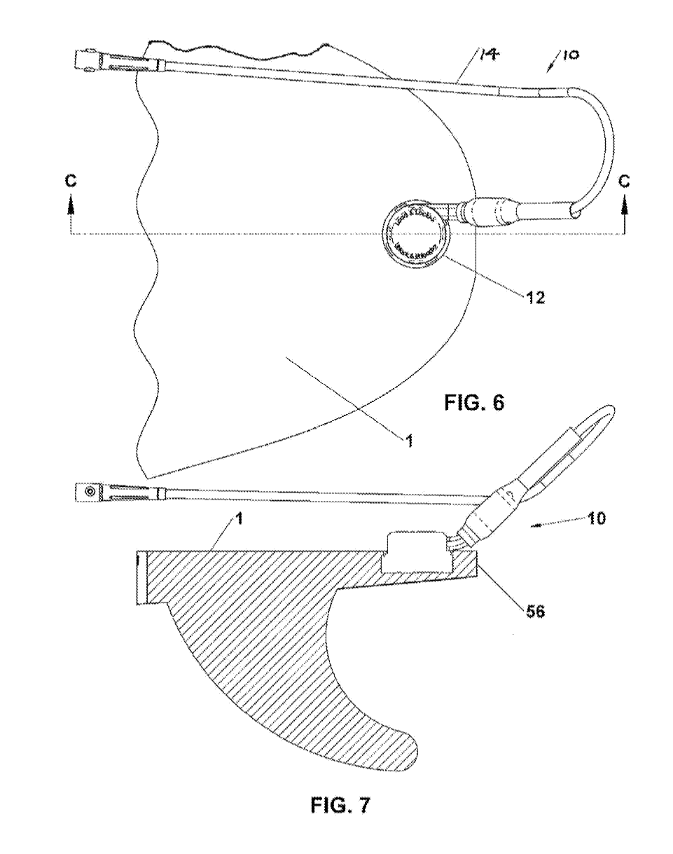

Referring now to FIGS. 1 through 10 of the drawings, there is shown a retractable surfboard leash system constructed in accordance with an embodiment of the present invention and is generally indicated at 10. As shown in FIG. 1, the retractable surfboard leash system 10 for a surfboard 1 may include a reel assembly 12 mounted fixedly on the upper rear portion of the surfboard 1, and a line or cord 14 connected at one end to the reel assembly 12 via connector 16, and connected at its opposite end fixedly to a user attachment device 18 such as an ankle strap for attaching the line 14 to the user.

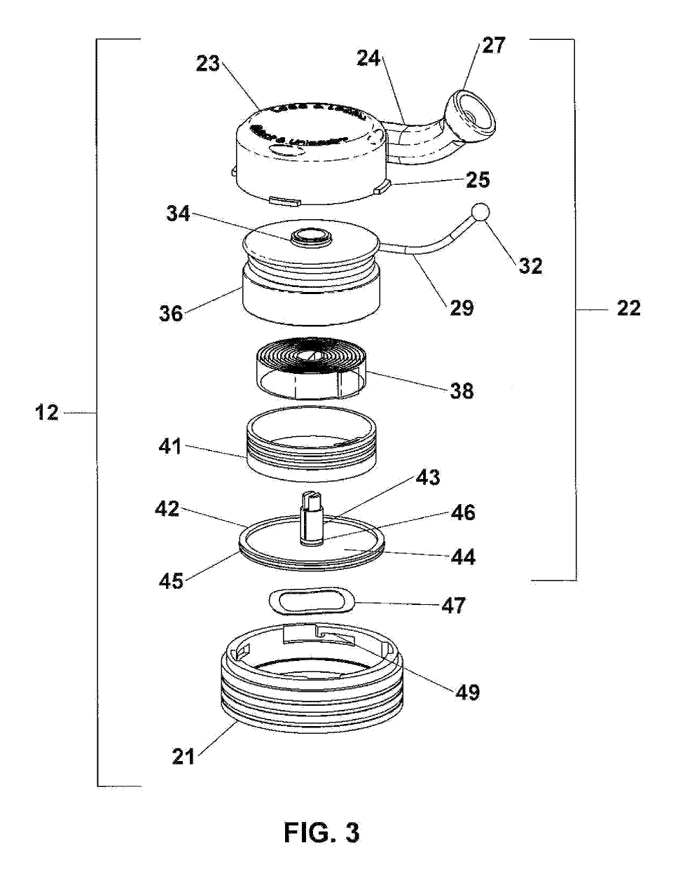

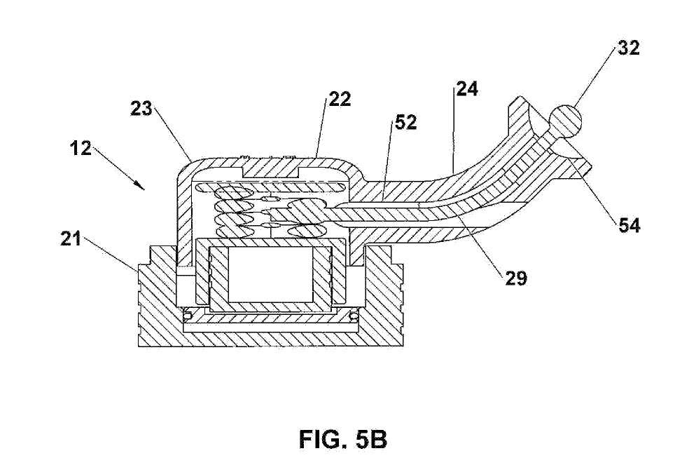

As best seen in FIGS. 3 and 5A, the reel assembly 12 may include a cup-shaped insert or receptacle 21 disposed within the top of and at the middle of the rear of the surfboard 1, and a reel 22 including a reel cover 23 having a generally L-shaped extending arm portion 24 terminating in an annular flange 27. The insert 21 may be manufactured/formed into the surfboard or may be mounted in an existing or created hole in the surfboard using epoxy or other suitable techniques. The cover 23 may include a plurality of outwardly extending locking tabs, such as locking tab 25, for mating with locking notches, such as locking notch 49, in the insert 21.

The reel assembly 12 as best seen in FIG. 3, may include a spool 36 having a retractable line or cord 29 attached thereto. An inner first end (not shown) of the line or cord 29 may be attached to the spool 36 and a portion of the line 29 may be wrapped around the spool 36. The line 29 may be composed of thin strong material such as a Spectra or other suitable material. The line 29 may extend through a passageway 52 in the L-shaped neck portion 24 and out the annular flange 27. The L-shaped neck portion 24 extends upward to elevate the line 29 above the surfboard 1 when extended to avoid damage to the surfboard. The second end of the line 29 may be terminated with a spherical stud 32 for connecting to the line 14 via the connector 16. A dynamic seal, such as an integral or separate O-ring seal 34 may be located on a top portion of the spool 36 to allow free rotation and provide an environmental barrier between the spool 36 and the cover 23.

A flat spiral spring 38 may be disposed in a bottom portion of the spool and have an outer end connected to the spool 36 to provide the capability to retract an extended portion of line 29. The spring 38 may be enclosed within the bottom portion of the spool 36 and a spring cover 41. The spring may be composed of suitable corrosion resistant material, such as elgiloy or other.

A flat bottom plate 42 may include an upwardly extending shaft 43 that extends through the spring cover 41 and engages the inner end of the flat spring 38 to allow the flat spring 38 to be able to store energy to retract the line 29, when the line/cord 29 is extended out of the reel 22. A shaft 35 extending downward from the inside of the cover 23 through the spool 36 may matingly engage and be fastened to a top portion of the shaft 43 of the flat bottom plate 42. The flat bottom plate 42 may also include a smooth flat surface 44 on which at least a portion of the bottom surface of the spring cover 41 rests so that the spool 36 may freely rotate within the reel 22. A dynamic seal such as an integral or separate O-ring seal 46 may be included at the bottom of the shaft 43 to engage an opening in the spring cover 41 to allow free rotation and provide an environmental seal between the spring cover 41 and the shaft 43. A washer 45 may be included in the outer edge of the flat bottom plate 42 to provide an environmental barrier between the reel 22 and the insert 21.

A flat spring 47 may be included in the bottom of the insert 21 to provide an upward force to the bottom of the reel 22 to keep the tabs of the cover 23 locked within the notches of the insert 21.

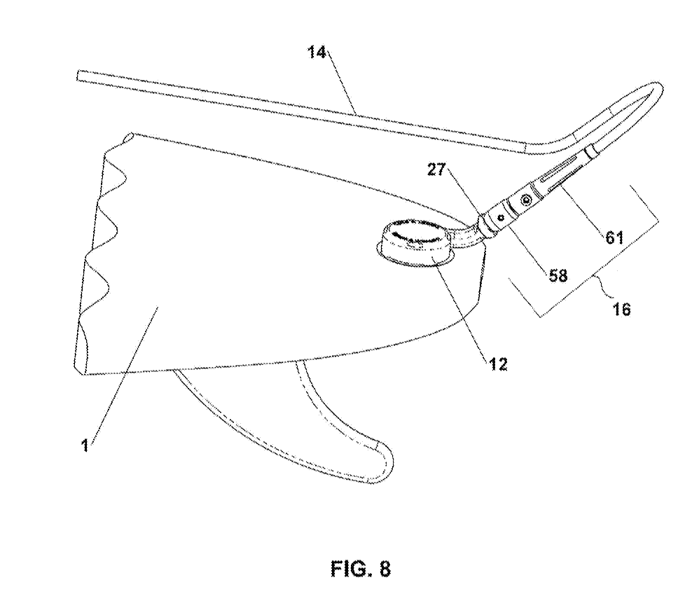

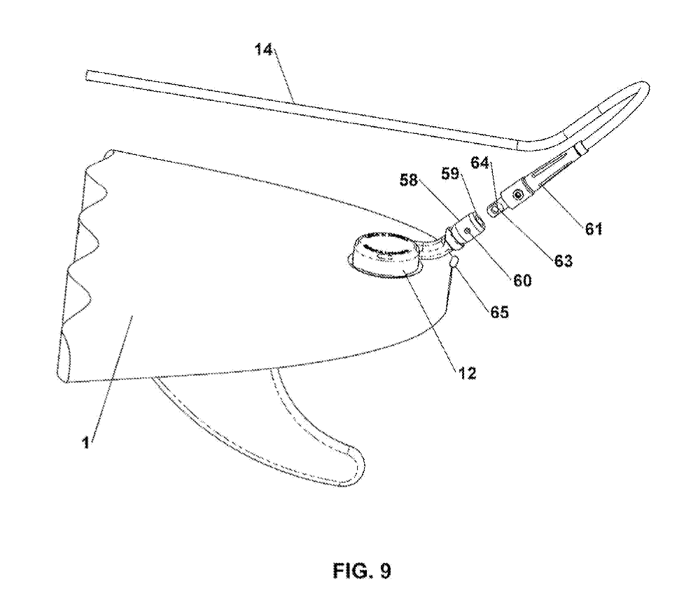

The annular flange 27 may include a recessed portion 54 for receiving a portion of the end of the connector 16. As best seen in FIGS. 8 and 9, the connector 16 may include a first connector section 58 attached to the line 29 using the spherical stud 32 (FIG. 3) and a second connector section 61 attached to a first end of the line 14. The first connector section 58 may include an opening 59 for receiving a narrowed engaging end 63 of the second connector section 61. The connector sections 58 and 61 may be attached together by securing a locking pin 65 through a side opening 60 in the first connector section 58 and engaging an opening 64 in the engaging end 63 of the second connector section 61. The second connector 61 may include a swivel to help prevent entanglement of one or both of the lines/cords.

The line 14 may be similar to that used for conventional surfboard leashes and constructed of the typical material used for surfboard leashes, such as nylon or the like, that may tolerate the wet conditions of use. The length of the line 14 may be between about zero and about four feet depending on the size of the surfboard. The line 29 may have a diameter significantly smaller than the diameter of line 14 and may also be constructed of a water tolerant material, such as nylon or the like. The length of the line 29 may be between about three feet and about nine feet. The user attachment device 18 may be similar to those used on conventional surfboard leashes and may be nine feet composed of conventional materials, such as Velcro®, magnets or other suitable materials.

In using the retractable surfboard leash system 10, a user may attach the user attachment device 18 to himself or herself, typically on one of his/her ankles. The length of the line 14 may be sufficient to allow the user to adequately move about the surfboard, but not so long that the user may become entangled in the line 14. The angularly upwardly inclined L-shaped extending neck portion 24 of the reel assembly 12 may elevate the line 14 sufficiently above the surfboard and direct it to the rear thereof, to help eliminate or reduce the possibility of the user stepping or tripping on the line 14 and to help prevent or at least reduce the possibility of the line 14 cutting into or otherwise damaging the surfboard. When the user desires to move further on the surfboard than is allowed by the length of the line 14, the line 29 may be extended or pulled out of the reel assembly 12 to provide the user the appropriate mobility with little or no restricting of his/her movement.

When the user moves back into the range allowed by the length of line 14, the extended portion of the thinner line 29 may be retracted back into the reel assembly 12. Should the user fall off the surfboard, a portion of the line 29 may be extended out of the reel assembly 12 due to the force of the fall to help prevent injury to the user and to help prevent the user from losing the surfboard in the water. When the user retrieves the surfboard, the line 29 retracts back into the reel assembly 12.

During use, the length of the line 14 may be sufficient to insure a buffer zone between the user and the surfboard. When the line 29 is retracted into the reel assembly 12, the surfboard is not pulled back into the user in such a manner that would be dangerous to the user or disruptive to the user for many applications or typical use of the surfboard.

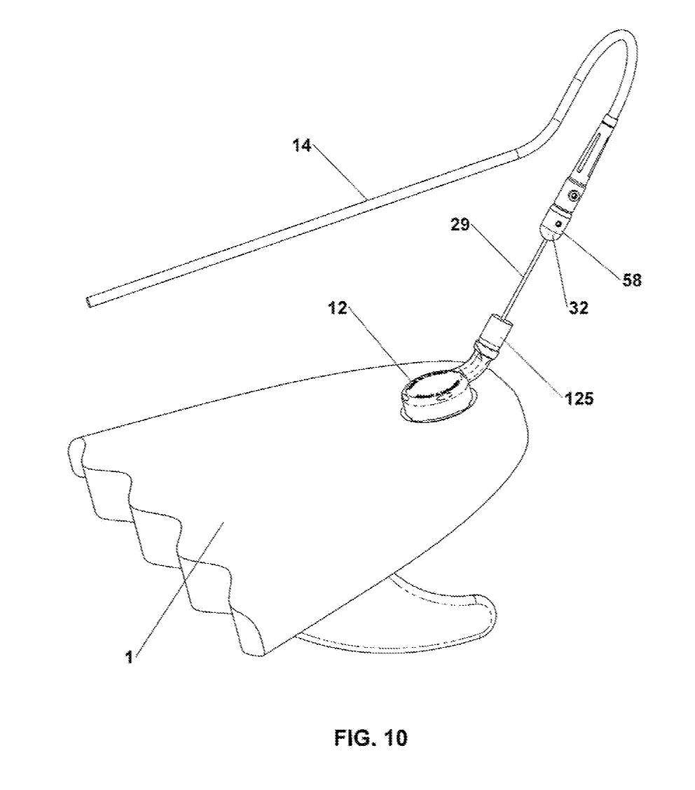

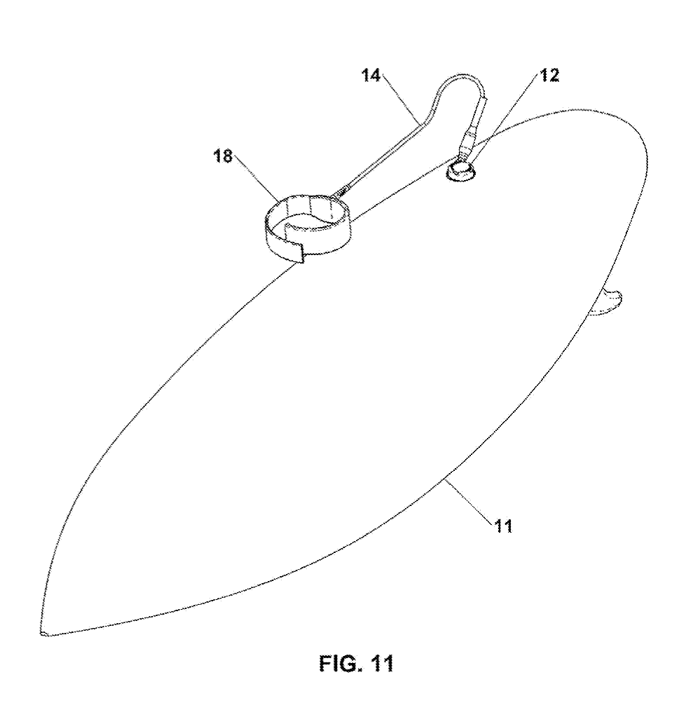

As shown in FIG. 10, a sliding block 125 may be fixed adjustably to the line 29 for setting the retraction length of the leash. The sliding block is generally cylindrical in shape and may be composed of a suitable rigid material such as urethane. The block 125 is fixed adjustably to the line 29 by suitable means (not shown), and serves as a stop to limit the length of the line 29 able to be retracted into the reel assembly.

Referring now to FIG. 11, the retractable surfboard leash system 10 is shown with its reel assembly 12 disposed in an optional alternative location on the surfboard 11, such as near one side of the rear of the surfboard instead of at the middle of the rear of the surfboard. The location of the reel assembly 12 may be determined by the preference of the user or by the manufacturer of the surfboard.

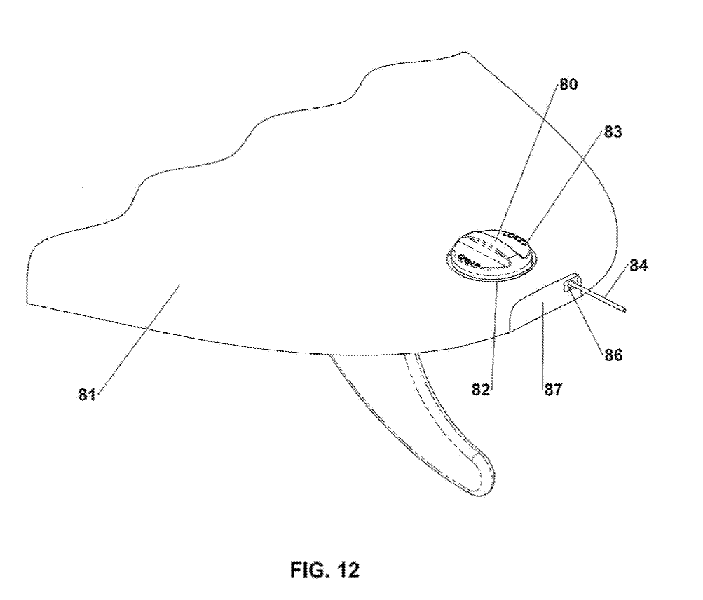

Referring now to FIG. 12, an alternate embodiment of mounting a reel assembly 80 on a surfboard 81 is shown. The reel assembly 80 may include an insert 82 formed or mounted into the surfboard 81, a reel 83 having a line or cord 84, and a conduit 86 providing a passageway between the insert 82 and the rear edge 87 of the surfboard 81 to allow the line 84 to exit at the rear of the surfboard. The use of and the other items of a retractable surfboard leash system using the reel assembly 80 may be substantially similar to the use of and those items of the retractable surfboard leash system 10.

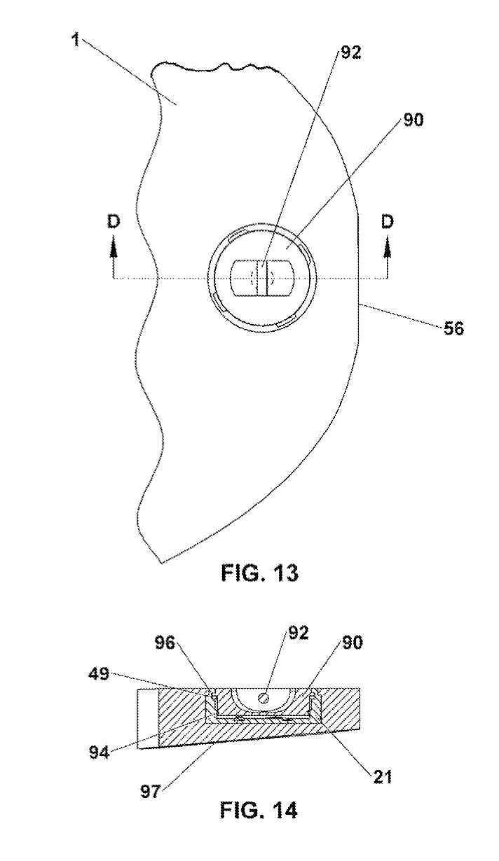

Referring now to FIGS. 13 and 14, an optional leash plug 90 is shown that may be mounted in the insert 21 of the retractable surfboard leash system 10. The leash plug 90 may include a crossbar 92 for attaching a conventional surfboard leash to the surfboard. A plurality of extending tabs, such as tab 96 mate with the locking notches, such as locking notch 49, of the insert 12. A washer or seal 94 provides an environmental barrier to protect the insert 12 and items such as a flat spring 97, which is similar to the spring 47. The insert 21 and leash plug 90 may be provided with a surfboard, such that a user may remove the optional leash plug 90 and replace it with a reel with a retractable cord, such as reel 22 described previously.

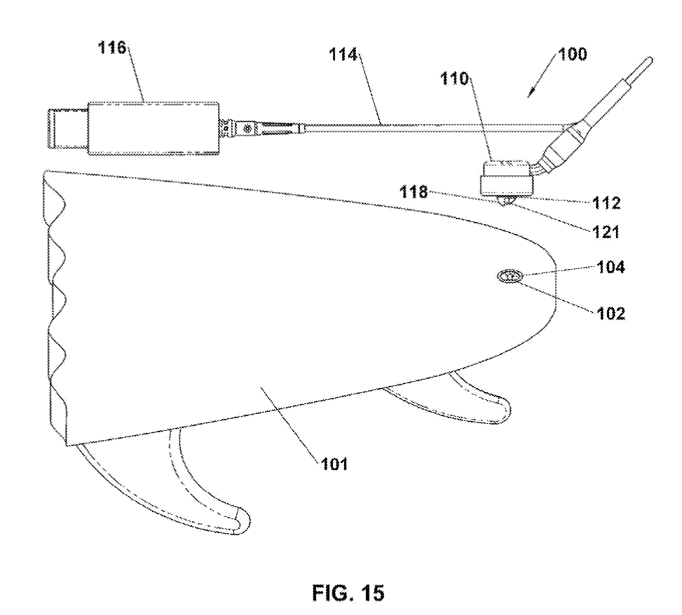

Referring now to FIG. 15, another embodiment of the retractable surfboard leash system is shown and is generally indicated at 100. The retractable surfboard leash system 100 may be substantially similar to the retractable surfboard leash system 10 except that it may be mounted on a surfboard 101 having a conventional leash plug 102. The retractable surfboard leash system 100 may include a reel assembly 110, a line or cord 114, and a user attachment device 116, all substantially similar to the corresponding items for the retractable surfboard leash system 10, with exception of an alternate mounting device 112 on the reel assembly 110. The mounting device 112 may include a first extending arm 118 and a second extending arm 121 to allow the reel assembly 110 to be clipped to the crossbar 104 of the conventional leash plug 102 of surfboard 101 using the arms 118, 121.

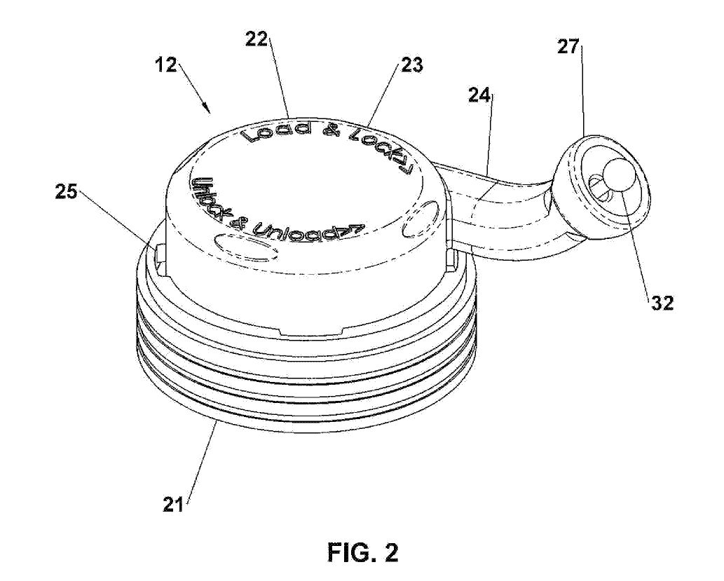

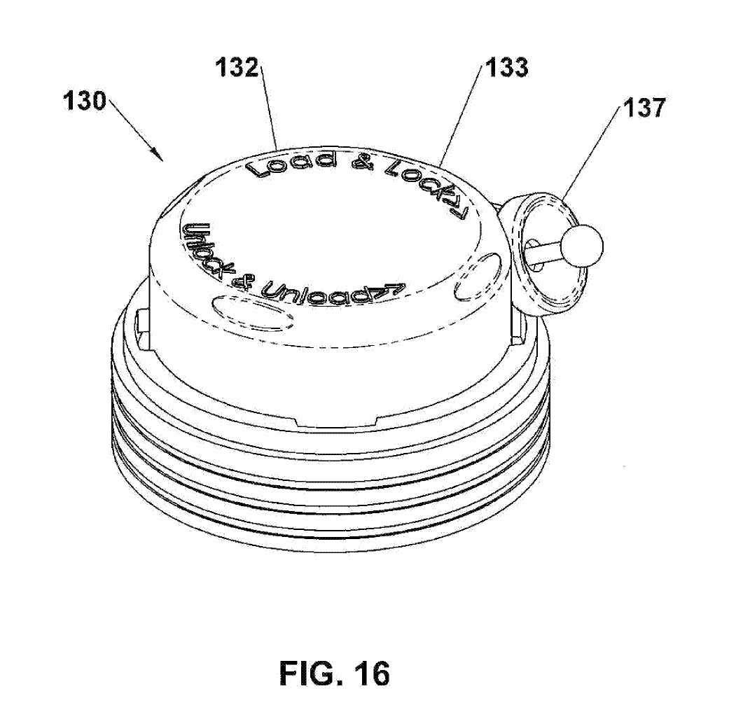

Referring now to FIG. 16, there is shown a reel assembly 130, which is constructed according to a further embodiment of the present invention, and which is similar to the reel assembly 12 of FIG. 2 except that it does not have an arm 24. The assembly 130 includes a reel 132 and a reel cover 133. An annular flange 137 is similar to the flange 27 (FIG. 2) for surrounding an outlet, but does not employ an extension arm such as the arm 24 (FIG. 2).

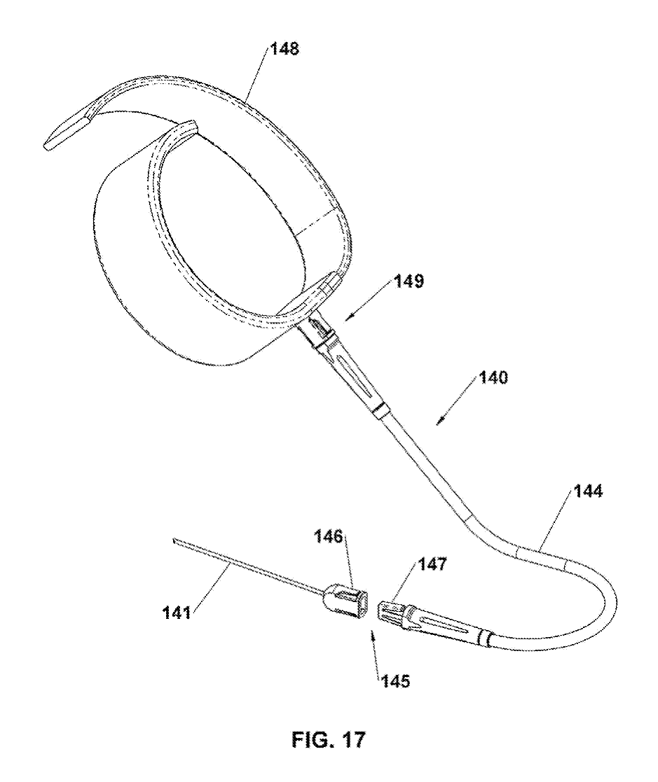

As shown in FIG. 17, there is shown yet another embodiment of a leash portion generally indicated at 140 of a surfboard leash system similar to the system 10 of FIG. 1. The leash portion 140 is a quick release assembly and includes a thin leash line 141 from a reel assembly (not shown) releasably connected at one of its ends to one end of a thick leash line 144 by a quick release connector 145. The connector 145 includes a snap or latch part 147 connected fixedly to the thick leash 144 and adapted to be secured releasably to a socket part connected to the thin leash 141. When the latch part 147 interengages with the socket part 146, the two parts are releasably attached together.

Similarly, another like quick release connector 149 interconnects the other end of the thick leash 144 to an attachment device 148, which is similar to the attachment device 18 of FIG. 1. In use, the quick release connectors 145 and 149 enable the leash portion 140 to have easily and conveniently interchangeable components. For example, the thick leash 144 can be separated from the thin leash 141 and the attachment device 148, and thus replaced with a different thick leash (not shown). In this manner, a worn or broken thick leash can be replaced with a new one. Or, alternatively, a different new thick leash of a different color or design may be used to replace the thick leash 144 in a convenient manner. The same may be true for the thin leash 141 and/or the attachment device 148.

It should be understood that when words such as “about,” “approximately,” “substantially” or the like are used herein, a tolerance of plus or minus 20 percent may be employed.

While particular embodiments of the present invention have been disclosed, it is to be understood that various different modifications are passing and one contemplated within the true spirit and scope of the appended claims. There is no intention, therefore, of limitations to the exact abstract or disclosure herein presented.

What is claimed is:

1. A surfboard leash system for a surfboard, comprising:
an insert adapted to be disposed within the surfboard;
a reel assembly releasably connected to the insert and having an arm portion terminating in an annular flange;
a first elongated line having a first end attached to the reel assembly and a second end capable of being extended from and retracted to the annular flange of the reel assembly; and
a second elongated line releasably connectable at a first end to the second end of the first elongated line and adapted to being releasably attached at a second end to a user of the surfboard.

2. The system of claim 1, wherein the reel assembly includes a plurality of tabs for mating with a corresponding plurality of notches in the insert.

3. The system of claim 1, wherein the insert includes a flat spring for providing an upward force to the bottom of the reel assembly to help maintain the mating between the tabs of the reel assembly and the notches of the insert.

4. The system of claim 1 further including a connector for connecting the second end of the first line to the first end of the second line, the connector including a first section attached to the second end of first line and a second section attached to the first end of the second line, the first section being releasably connectable to the second section.

5. The system of claim 4, wherein the second end of the first line includes an enlarged portion for attaching to the first section of the connector.

6. The system of claim 4, wherein the connector includes an engageable pin for releasably connecting the first section of the connector to the second section of the connector.

7. The system of claim 1, wherein the reel assembly includes a spiral spring for retracting the first line.

8. The system of claim 1 further including a leash plug adapted to be attached alternatively to the insert and adapted to secure another leash to the surfboard without the use of a reel.

9. A method of making a surfboard leash system, comprising:
releasably attaching a reel assembly having a retractable leash line to an insert fixed to the surfboard; and
alternatively releasably connecting a leash plug to the insert.

10. A surfboard leash system for a surfboard, comprising:
an insert fixed to the surfboard;
a reel assembly releasably connected to the insert;
a leash plug adapted to be releasably attached to the insert; and
wherein the reel assembly can be quickly removed from the surfboard, and the leash plug detachably connected to the insert.

11. The system of claim 1 further including a sliding block for connecting to the first line to limit the retraction length of the leash.

12. The system of claim 1, wherein the first line is composed of a thin strong Spectra material.

13. The system of claim 1, wherein the reel assembly includes an alternate mounting device for attachment releasably to a leash plug.

14. The system of claim 1, further including a pair of quick release connectors to fasten the first line to the second line, and to fasten the second line to an attachment device.

15. A surfboard leash system for a surfboard, according to claim 1, further including conduit means for providing access from the insert to the rear edge of the surfboard; the first elongated line having a first end attached to the reel assembly and a second end extending through the conduit means and capable of being extended from and retracted to the rear edge of the surfboard.

16. The system of claim 15, wherein the reel assembly includes means for mating with a corresponding plurality of latching means in the insert.

17. The system of claim 15, wherein the reel assembly includes a coil spring composed of corrosion resistant material.

18. The system of claim 15 wherein the corrosion resistant material is elgiloy.

19. a surfboard leash system for a surfboard, comprising:
a reel assembly attached to the surfboard;
a leash line including a line portion disposed within the reel having a housing;
a spool having the line portion wrapped thereabout; and
a set of seals for providing an environmental barrier to help protect the components of the seal.

20. A system according to claim 19, wherein the seals are O-ring seals.
